(19) United States
(12) Patent Application Publication
(10) Pub. No.: US 2020/0149672 A1
(43) Pub. Date: May 14, 2020

(54) Pipe Repair Clamp Sealing Assembly

(71) Applicant: CTG, Inc., Houston, TX (US)

(72) Inventors: Cory Jackson, Houston, TX (US); Adam Graebner, Houston, TX (US)

(73) Assignee: CTG, Inc., Houston, TX (US)

(21) Appl. No.: 16/678,405

(22) Filed: Nov. 8, 2019

Related U.S. Application Data
(60) Provisional application No. 62/757,710, filed on Nov. 8, 2018.

(51) Int. Cl. F16L 55/172

(52) U.S. Cl. CPC F16L 55/172

(57) ABSTRACT

A pipe repair clamp includes a clamp body which defines a central opening into which a pipe is received. Gaskets are located within the clamp body which seal against the pipe on either side of a leak. The gaskets are provided with fiber shield reinforcement to prevent extrusion of the gaskets.

### BACKGROUND OF THE INVENTION

### 1. Field of the Invention

The invention relates generally to pipe repair clamps arrangements.

### 2. Description of the Related Art

Leaks for pipes and pipelines are often conducted by placing a pipe repair clamp over the leak point. Conventional gaskets and sealing members used in these arrangements are prone to extrusion during use resulting from high temperatures and pressure from leaked fluid. The gaskets or seals tend to creep away from the leak over time and can be prone to failure, with undesirable results.

### SUMMARY OF THE INVENTION

The invention provides a pipe repair clamp which includes a clamp body having an opening into which a pipe is received. At least one, but preferably two, annular gaskets are disposed within the opening to seal against the pipe. The gaskets each present axial side surfaces which lie normal to the axis of the pipe when the clamp body surrounds the pipe. The gaskets also present an outer radial surface which contacts the clamp body. For each gasket, a fabric shield covers one axial side surface and at least a portion of the outer radial surface. Preferably, the fabric shield is formed of aramid fiber.

When in place around a pipe, the fabric shields prevent extrusion of the gasket material. Therefore, it is preferred that the fabric shield for each gasket be located on the axial side surface which faces away from the pipe leak to provide an effective sealing assembly for the pipe repair clamp.

Preferably, the gaskets are formed by molding using a mold with separable halves (a two-part mold). The fabric shield is placed within one half of the mold and elastomeric material is poured into the mold half to bond with the fabric shield. Thereafter, the mold halves are joined and pressure may be applied. In this fashion, the fabric shield and elastomeric body portion of the gasket are integrally formed.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is an isometric view of an exemplary pipe repair clamp constructed in accordance with the present invention.

FIG. 2 is a cross-sectional view of portions of the sealing assembly for the pipe repair clamp of FIG. 1.

FIG. 3 is an external view of an exemplary gasket used with the pipe repair clamp of FIG. 1.

FIG. 4 is a cross-sectional view of the gasket of FIG. 3.

FIG. 5 is a schematic view of an exemplary mold used to form gaskets in accordance with the present invention.

FIG. 6 is a schematic view of the mold of FIG. 5 now with the mold closed.

### DETAILED DESCRIPTION OF THE PREFERRED EMBODIMENTS

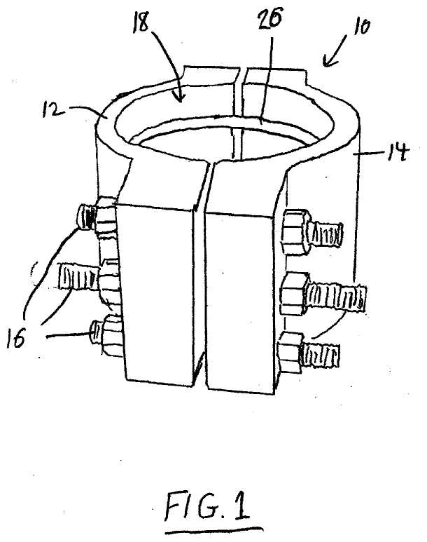

FIG. 1 depicts an exemplary repair clamp in accordance with the present invention. The clamp features a clamp body 10 which is shaped and sized to surround a pipe to be repaired. In the depicted embodiment, the clamp body 10 includes first and second clamp halves 12, 14 that are shaped and sized to fit in a complementary manner around that exterior of a pipe to be repaired. The two halves 12, 14 may be separate or movably secured to each other via a hinge (not shown) in a manner known in the art. Nut-and-bolt fasteners 16 are typically used to fasten the clamp halves 12, 14 together. Alternatively, the clamp body 10 may be unitary rather than being made up of separate components.

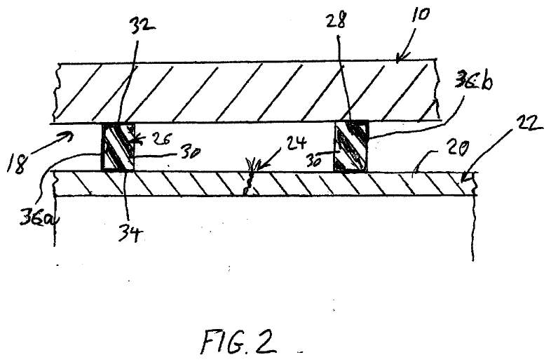

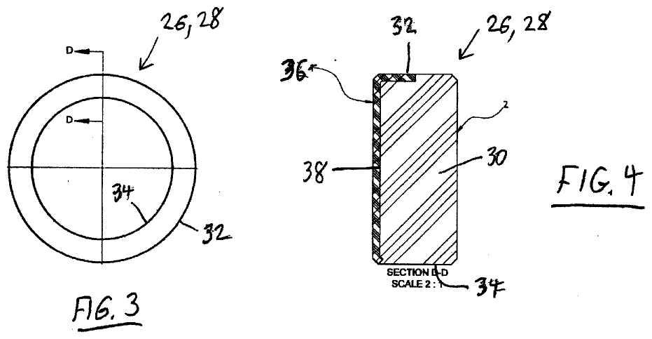

The pipe repair clamp body 10 defines a central opening 18 into which a pipe is received when in use. FIG. 2 is a cross-sectional view showing a pipe repair clamp 10 secured around the outer surface 20 of pipe 22 having a leak 24. Compressible gaskets 26, 28, constructed in accordance with the present invention, are disposed within the central opening 18 of the clamp 10. As shown in FIG. 2, the gaskets 26, 28 are located on each axial side of the leak 24 and are compressed against the pipe 22 by the clamp halves 12, 14. Further details regarding the gaskets 26, 28 are shown in FIGS. 3 and 4.

The gaskets 26, 28 have a main body portion 30 that is primarily formed of an elastomer that is highly resistant to high temperatures and/or pressures. The gaskets 26, 28 are annular and present a clamp-contacting radially outer surface 32 and a pipe-contacting radially inner surface 34. The gaskets 26, 28 may be rectangular or rounded or have other cross-sectional shapes. However, the exemplary gaskets 26, 28 are shown as rectangular here for ease of description. The gaskets 26, 28 present axial side surfaces 38 which lie substantially normal to the axis of the pipe 22 when the clamp body 10 is secured around the pipe 22.

For each gasket 26, 28, a fabric shield 36, best shown in FIG. 4, covers one axial side surface 38 of the main body portion 30 as well as a portion of the radially outer surface 32. This configuration helps prevent extrusion of the elastomer forming the main body portion 30 once installed. Preferably, the fabric shield 36 covers roughly one half of the outer surface 32. The fabric shield 36 is preferably made of aramid synthetic fiber such as KEVLAR® fabric.

When the clamp 10 is in place around a pipe 22, the fabric shield 36 of each gasket 26, 28 is oriented away from the leak 24, as shown in FIG. 2. The fabric shield 36 will help prevent extrusion of the material making up the main body portion 30. As illustrated by FIG. 2, the first fabric shield 36a of the first gasket 26 is located on the axial side surface 38a which faces away from the second gasket 28. The second fabric shield 36b of the second gasket 28 faces away from the first gasket 26. The inventors have found that orientation of the fabric shields 36a, 36b in this manner such that the fabric shields face away from each other and the leak 24 is effective to preclude deformation and extrusion of the gaskets 26, 28. Additionally, extension of the fabric shields 36a, 36b over the outer surface 32 of the gaskets 26, 28 prevents extrusion of the main body portions 30 along the clamp body 10.

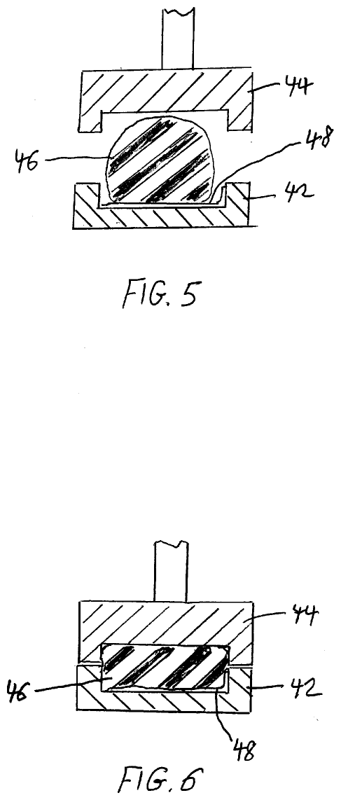

The gaskets 26, 28 are preferably created by molding. A currently preferred technique for molding is to use a two-part mold such as the mold 40 shown in FIGS. 5-6. The mold 40 is a two-part mold made up of a lower half 42 and an upper half 44. Prior to filling the mold 40 with the elastomeric material 46 used to form the main body portion 30, fabric 48 is placed into the lower half of the mold on the surfaces which would correspond to axial side surface 38 and radially outer surface 32 (see FIG. 5). As the elastomeric material 46 is poured into the lower half of the mold, it will bond with the fabric 48. The upper half 44 of the mold 40 is placed onto the top of the lower half 42 of the mold which will stretch the fabric 48 and bond the fabric to the elastomeric material 46. The fabric 48 is integrally formed with the elastomeric material 46 for the main body portion.

What is claimed is:

1. A pipe repair clamp comprising:
a clamp body which defines an opening into which a pipe may be received;
a gasket located within the opening, the gasket having a main body portion formed of an elastomeric material; and
a fabric shield which covers a portion of main body portion to limit extrusion of the main body portion.

2. The pipe repair clamp of claim 1 wherein:
the main body portion presents a radially outer surface; and
the fabric shield covers at least a portion of the radially outer surface.

3. The pipe repair clamp of claim 1 wherein:
the main body portion presents an axial side surface which lies substantially normal to the axis of the pipe when the clamp body is disposed around the pipe; and
the fabric shield covers at least a portion of the axial side surface.

4. The pipe repair clamp of claim 3 wherein the fabric shield covers substantially all of the axial side surface.

5. The pipe repair clamp of claim 1, wherein:
the fabric shield is formed of aramid fiber.

6. The pipe repair clamp of claim 1 wherein:
a second gasket is located within the opening;
the second gasket presents a second axial side surface which lies substantially normal to the axis of the pipe when the clamp body is disposed around the pipe;
a fabric shield which covers the second axial side surface; and
wherein the second axial surface is facing away from the first axial side surface.

7. The pipe repair clamp of claim 1 wherein the gasket further comprises:
a main body portion formed of an elastomeric material; and
wherein the fabric shield is integrally formed with the main body portion as the gasket is formed in a mold.

8. A pipe repair clamp comprising:
a clamp body which defines an opening into which a pipe may be received;
a gasket located within the opening, the gasket presenting an axial side surface which lies substantially normal to the axis of the pipe when the clamp body is disposed around the pipe; and
a fabric shield which covers the axial side surface.

9. The pipe repair clamp of claim 8 wherein:
the main body portion presents a radially outer surface; and
the fabric shield covers at least a portion of the radially outer surface.
